(19) United States
(12) Patent Application Publication
(10) Pub. No.: US 2018/0004777 A1
(43) Pub. Date: Jan. 4, 2018

(54) DATA DISTRIBUTION ACROSS NODES OF A DISTRIBUTED DATABASE BASE SYSTEM

(71) Applicants: Brian J. BULKOWSKI, Menlo Park, CA (US); Venkatachary SRINIVASAN, Sunnyvale, CA (US)

(72) Inventors: Brian J. BULKOWSKI, Menlo Park, CA (US); Venkatachary SRINIVASAN, Sunnyvale, CA (US)

(21) Appl. No.: 15/488,511

(22) Filed: Apr. 16, 2017

Related U.S. Application Data
(60) Provisional application No. 62/322,793, filed on Apr. 15, 2016.

(51) Int. Cl. G06F 17/30

(52) U.S. Cl. CPC G06F 17/30283; G06F 17/3033; G06F 17/30584

(57) ABSTRACT

A method of a data distribution across nodes of a Distributed Database Base System (DDBS) includes the step of hashing a primary key of a record into a digest, wherein the digest is part of a digest space of the DDBS. The method includes the step of partitioning the digest space of the DDBS into a set of non-overlapping partitions. The method includes the step of implementing a partition assignment algorithm. The partition assignment algorithm includes the step of generating a replication list for the set of non-overlapping partitions. The replication list includes a permutation of a cluster succession list. A first node in the replication list comprises a master node for that partition. A second node in the replication list comprises a first replica. The partition assignment algorithm includes the step using the replication list to generate a partition map.

### CROSS-REFERENCE TO RELATED APPLICATIONS

This application incorporates by reference U.S. patent application No. 62/322,793 titled ARCHITECTURE OF A REAL-TIME OPERATIONAL DBMS and filed on 15-Apr.-2016.

### BACKGROUND OF THE INVENTION

### 1. Field

This application relates generally to database systems, and more specifically to a system, article of manufacture, and method for data distribution across nodes of a Distributed Database Base System (DDBS).

### 2. Related Art

A distributed database can include a plurality of database nodes and associated data storage devices. A database node can manage a data storage device. If the database node goes offline, access to the data storage device can also go offline. Accordingly, redundancy of data can be maintained. However, maintaining data redundancy can have overhead costs and slow the speed of the database system. Therefore, methods and systems of data distribution across nodes of a Distributed Database Base System (DDBS) can provide improvements to the management of distributed databases.

### BRIEF SUMMARY OF THE INVENTION

A method of a data distribution across nodes of a Distributed Database Base System (DDBS) includes the step of hashing a primary key of a record into a digest, wherein the digest is part of a digest space of the DDBS. The method includes the step of partitioning the digest space of the DDBS into a set of non-overlapping partitions. The method includes the step of implementing a partition assignment algorithm. The partition assignment algorithm includes the step of generating a replication list for the set of non-overlapping partitions. The replication list includes a permutation of a cluster succession list. A first node in the replication list comprises a master node for that partition. A second node in the replication list comprises a first replica. The partition assignment algorithm includes the step using the replication list to generate a partition map

### BRIEF DESCRIPTION OF THE DRAWINGS

FIG. 1 illustrates an example database platform architecture, according to some embodiments.

FIG. 2 depicts an exemplary computing system that can be configured to perform any one of the processes provided herein.

FIG. 3 illustrates an example data distribution across nodes of DDBS, according to some embodiments.

FIG. 4 illustrates an example partition assignment algorithm according some embodiments.

FIG. 5 illustrates an example table that includes an example partition assignment algorithm, according to some embodiments.

FIG. 6 illustrates another example of data distribution across nodes of a DDBS, according to some embodiments.

The Figures described above are a representative set, and are not an exhaustive with respect to embodying the invention.

### DESCRIPTION

Disclosed are a system method, and article of manufacture for architecture of a real-time operational DBMS. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth, in other instances, well-known structures, materials, or operations are not shown or described in detail to avoid obscuring aspects of the invention.

The schematic flow chart diagrams included herein, are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Central processing unit (CPU) can be the electronic circuitry within a computer that carries out the instructions of a computer program by performing the basic arithmetic, logical, control and input/output (I/O) operations specified by the instructions.

Database management system (DBMS) can be a computer software application that interacts with the user, other applications, and the database itself to capture and analyze data.

Decision engine can be computer-based information system that supports business or organizational decision-making activities.

Dynamic random-access memory (DRAM) can be a type of random-access memory that stores each bit of data in a separate capacitor within an integrated circuit.

Hash function is any function that can be used to map data of arbitrary size to data of fixed size. The values returned by a hash function are called hash values, hash codes, digests, or simply hashes. One use is a data structure called a hash table, widely used in outer software for rapid data lookup.

Real-time bidding (RTB) can be a means by which advertising inventory is bought and sold on a per-impression basis via programmatic instantaneous auction.

Real time can be substantially real time, for example, assuming networking and processing latencies, etc.

RIPEMD (RACE Integrity Primitives Evaluation Message Digest) a family of cryptographic hash functions.

Solid-state drive (SSD) (although it contains neither an actual disk nor a drive motor to spin a disk) can be a solid-state storage device that uses integrated circuit assemblies as memory to store data persistently.

Exemplary Computer Architecture and Systems

Various methods and systems are provided herein for building a distributed database system that can smoothly handle demanding real-time workloads while also providing a high-level of fault-tolerance. Various schemes are provided for efficient clustering and data partitioning for automatic scale out of processing across multiple nodes and for optimizing the usage of CPU, DRAM, SSD and network to efficiently scale up performance on one node.

The distributed database system can include interactive online services. These online services can be, high scale and need to make decisions, within a strict SLA by reading from and writing to a database containing billions of data items at a rate of millions of operations per second with sub-millisecond latency.

Real-time Internet applications may be high scale and need to make decisions within a strict SLA. These applications can read from and write to a database containing billions of data items at a rate of millions of operations per second with sub-millisecond latency. Such applications, therefore, can have extremely high throughput, low latency and high uptime. Furthermore, such real-time decision systems have a tendency to increase their data usage over time for improving the, quality of their decisions, i.e. the more data that can be accessed in a fixed amount of time, the better the decision itself. In one example, Internet advertising technology can use real-time bidding. This ecosystem can include different players interacting with each other in real-time to provide a correct advertisement to a user, based on that user's behavior.

Database Platform Architecture

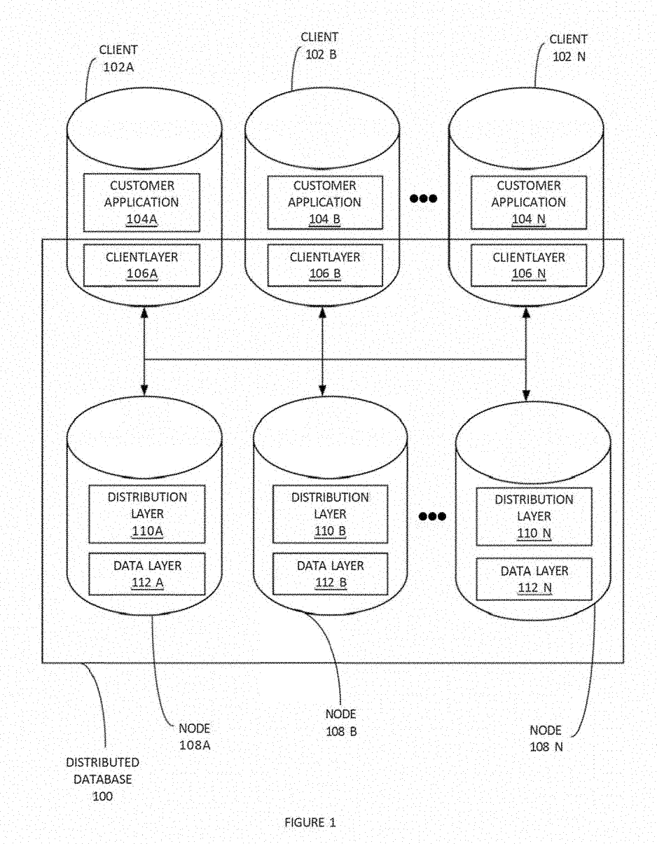

FIG. 1 illustrates an example database platform architecture 100, according to some embodiments. Distributed system architecture can be provided that addresses issues related to scale out under the sub-topics of cluster management, data distribution and/or client/server interaction. The database platform can be modeled on the classic shared-nothing database architecture. The database cluster can include a set of commodity server nodes, each, of which has CPUs, DRAMs, rotational disks (HDDs) and/or optional flash storage units (SSDs). These nodes can be connected to each other using a standard TCP/IP network.

Client applications issue primary index based read, write, batch operations, and/or secondary index based queries, against the cluster via client libraries that provide a native language interface idiomatic to each language. Client libraries can be available for popular programming languages, viz. Java, C/C++, Python, PHP, Ruby, JavaScript and C#.

In one example embodiment, FIG. 1 shows, in a block diagram format, a distributed database system (DDBS) 100 operating in a computer network according to an example embodiment. In some examples, DDBS 100 can be an Aerospike® database. DDBS 100 can typically be a collection of databases that can be stored at different computer network sites (e.g. a server node). Each database may involve different database management systems and different architectures that distribute the execution of transactions. DDBS 100 can be managed in such a way that it appears to the user as a centralized database. It is noted that the entities of distributed database system (DDBS) 100 can be functionally connected with a PCIe interconnections (e.g. PCIe-based switches, PCIe communication standards between various machines, bridges such as non-transparent bridges, etc.). In some examples, some paths between entities can be implemented with Transmission Control Protocol (TCP), remote direct memory access (RDMA) and the like.

DDBS 100 can be a distributed, scalable NoSQL database, according to some embodiments. DDBS 100 can include, inter olio, three main layers: a client layer 106 A-N, a distribution layer 110 A-N and/or a data layer 112 A-N. Client layer 106 A-N can include various DDBS client libraries. Client layer 106 A-N can be implemented as a smart client. For example, client layer 106 A-N can implement a set of DDBS application program interfaces (APIs) that are exposed to a transaction request. Additionally, client layer 106 A-N can also track cluster configuration and manage the transaction requests, making any change in cluster membership completely transparent to customer application 104 A-N.

Distribution layer 110 A-N can be implemented as one or more server cluster nodes 108 A-N, Cluster nodes 108 A-N can communicate to ensure data consistency and replication across the cluster. Distribution layer 110 A-N can use a shared-nothing architecture. The shared-nothing architecture can be linearly scalable. Distribution layer 110 A-N can perform operations to ensure database properties that lead to the consistency and reliability of the DDBS 100. These properties can include Atomicity, Consistency, Isolation, and Durability.

Atomicity. A transaction is treated as a unit of operation. For example, in the case of a crash, the system should complete the remainder of the transaction, or it may undo all the actions pertaining to this transaction. Should a transaction fail, changes that were made to the database by it are undone i e.g. rollback).

Consistency. This property deals with maintaining consistent data in a database system. A transaction can transform the database from one consistent state to another. Consistency falls under the subject of concurrency control.

Isolation. Each transaction should carry out its work independently of any other transaction that may occur at the same time.

Durability. This property ensures that once a transaction s results are permanent in the sense that the results exhibit persistence after a subsequent shutdown or failure of the database or other critical system. For example, the property of durability ensures that after a COMMIT of a transaction, whether it is a system crash or aborts of other transactions, the results that are already committed are not modified or undone.

In addition, distribution layer 110 A-N can ensure that be cluster remains fully operational when individual server nodes are removed from or added to the duster. On each server node, a data layer 112 A-N can manage stored data on disk. Data layer 112 A-N can maintain indices corresponding to the data in the node. Furthermore, data layer 112 A-N be optimized for operational efficiency, for example, indices can be stored in a very tight format to reduce memory requirements, the system can be configured to use low level access to the physical storage media to further improve performance and the likes. It is noted, that in some embodiments, no additional cluster management servers and/or proxies need be set up and maintained other than those depicted in FIG. 1.

In some embodiments, cluster nodes 108 A-N can be an Aerospike Smart Cluster™. Cluster nodes 108 A-N can have a shared-nothing architecture (e.g. there is no single point of failure (SPOF)). Various nodes in the cluster can be substantially identical. For example, cluster nodes 108 A-N can start with a few nodes and then be scaled up by adding additional hardware. Cluster nodes 108 A-N can scale linearly. Data can be distributed across cluster nodes 108 A-N can using randomized key hashing (e.g. no hot spots, just balanced load). Nodes can be added and/or removed from cluster nodes 108 A-N can without affecting user response time (e.g. nodes rebalance among themselves automatically). A Paxos algorithm can be implemented such that all cluster nodes agree to a new cluster state. Paxos algorithms can be implemented for cluster configuration and not transaction commit.

Auto-discovery. multiple independent paths can be used for nodes discovery—an explicit heartbeat message and/or via other kinds of traffic sent to each other using the internal cluster inter-connects. The discovery algorithms can avoid mistaken removal of nodes during temporary congestion. Failures along multiple independent paths can be used to ensure high confidence in the event. Sometimes nodes can depart and then join again in a relatively short amount of time (e.g. with router glitches) DDBS 100 can avoid race conditions by enforcing the order of arrival and departure events.

Balanced Distribution. Once consensus is achieved and each node agrees on both the participants and their order within the cluster, a partitions algorithm (e.g. Aerospike Smart Partitions™ algorithm) can be used to calculate the master and replica nodes for any transaction. The partitions algorithm can ensure no hot spots and/or query volume is distributed evenly across all nodes. DDBS 100 can scale without a master and eliminates the need for additional configuration that is required in a sharded environment.

Synchronous Replication. The replication factor can, be configurable. For example, come deployments use a replication factor of two (2). The cluster can be rack-aware and/or replicas are distributed across racks to ensure availability in the case of rack failures. For writes with immediate consistency, writes are propagated to all replicas before committing the data and returning the result to the client. When a cluster is recovering from being partitioned, the system can be configured to automatically resolve conflicts between different copies of data using timestamps. Alternatively, both copies of the data can be returned to the application for resolution at that higher level. In some cases, when the replication factor can't be satisfied, the cluster can be configured to, either decrease the replication factor and retain all data, or begin evicting the oldest data that is marked as disposable. If the cluster can't accept any more data, it can begin operating in a read-only mode until new capacity becomes available, at which point it can automatically begin accepting application writes.

Self-Healing and Self-Managing. DDBS 100 and cluster nodes 108 A-N can be self-healing. If a node fails, requests can be set to automatically fail-over. When a node fails or a new node is added, the cluster automatically re-balances and migrates data. The cluster can be resilient in the event of node failure during re-balancing itself. If a cluster node receives a request for a piece of data that it does not have locally, it can satisfy the request by creating, an internal proxy for this request, fetching the data from the real owner using the internal cluster interconnect, and subsequently replying to the client directly. Adding capacity can include installing and/or configuring a new server and cluster nodes 108 A-N can automatically discover the new node and re-balances data (e.g. using a Paxos consensus algorithm).

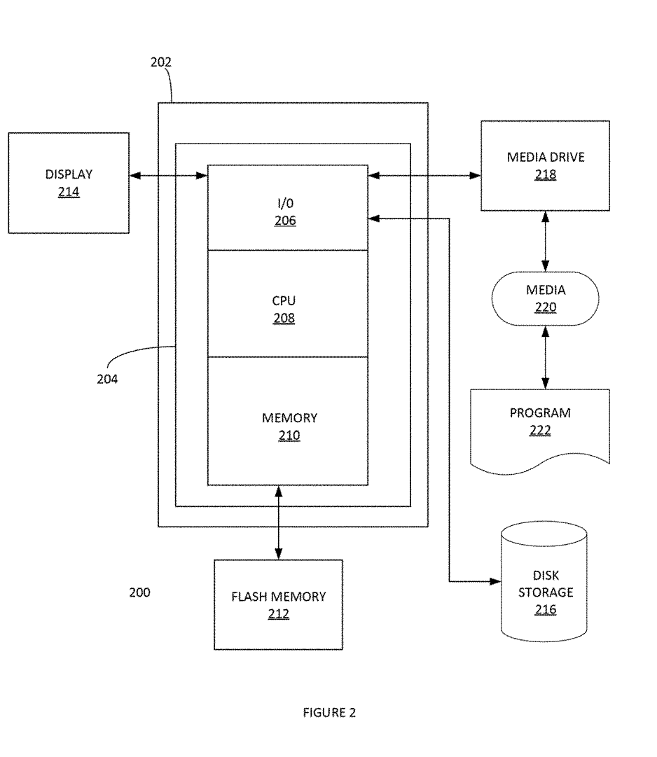

FIG. 2 depicts an exemplary computing system 200 that can be configured to perform any one of the processes provided herein. In this context, computing system 200 may include, for example, a processor, memory, storage, and I/O devices (e.g., monitor, keyboard, disk drive, Internet connection, etc.). However, computing system 200 may include circuitry or other specialized hardware for carrying out some or all aspects of the processes. In some operational settings, computing system 200 may be configured as a system that includes one or more units, each of which is configured to carry out some aspects of the processes either in software, hardware or some combination thereof.

FIG. 2 depicts computing system 200 with a number of components that may be used to perform any of the processes described herein. The main system 202 includes a motherboard 204 having an I/O section 206, one or more central processing units (CPU) 208, and a memory section 210, which may have a flash memory card 212 related to it. The I/O section 206 can be connected to a display 214, a keyboard and/or other user input (not shown), a disk storage unit 216, and a media drive unit 218. The media drive unit 218 can read/write a computer-readable medium 220, which can contain programs 222 and/or data. Computing system 200 can include a web browser. Moreover, it is noted that computing system 200 can be configured to include additional systems in order to fulfill various functionalities. Computing system 200 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

Cluster Management

Methods and systems of cluster management are now provided. A cluster management subsystem can handle node membership and/or ensure the nodes in the system come to a consensus on the current membership of the cluster. Events, such as, inter alia: network faults and node arrival or departure, can trigger cluster membership changes. Such events can be both planned and unplanned. Examples of such events include, inter alia: randomly occurring network disruptions, scheduled capacity increments, hardware and software upgrades. Various objectives of the cluster management subsystem can include, inter alia: arrive at a single consistent view of current cluster members across the nodes in the cluster; automatic detection of new node arrival/departure and seamless cluster reconfiguration; detect network faults and be resilient to such network flakiness; minimize time to detect and adapt to cluster membership changes; etc.

Cluster view implementations are now provided. Each node can be automatically assigned a unique node identifier. This can be a function of its mac address and/or the listening port identity. A cluster view can be defined by the tuple: <cluster_key, succession_list>. Where,

‘cluster_key’ is a randomly generated eight (8) byte value that identifies an instance of the cluster view ‘succession_list’ can be the set of unique node identifiers that are part of the cluster. The cluster key can uniquely identify the current cluster membership state and/or changes each time the cluster view changes. This can enable nodes to differentiate between two cluster views with an identical set of member nodes.

A change to the cluster view can have an effect on operation latency and, in general, the performance of the entire system. Accordingly, quick detection of node arrival/departure events may be followed by an efficient consensus mechanism to handle any changes to the cluster view.

In one example, a cluster discovery process can be provided. Node arrival or departure can be detected via heartbeat messages exchanged periodically between nodes. A node in the cluster can maintain an adjacency list. This can be the list of nodes from which it received heartbeat message recently. Nodes departing the cluster can be detected by the absence of heartbeat messages for a configurable timeout interval and are removed from the adjacency list. Various objectives of the detection mechanism can include, inter alia: to avoid declaring nodes as departed because of sporadic and momentary network glitches; and/or to prevent an erratic node to join and depart frequently from the cluster. A node could behave erratically due to system level resource bottlenecks in the use of CPU, network, disk, etc.

f some example embodiments, these objectives of the detection mechanism can be achieved as follows. Surrogate heartbeats can be implemented. In addition to regular heartbeats, nodes can use other messages, which can be exchanged between nodes. For example, replica writes can be a natural surrogate for heartbeat messages. This can ensure that, as long as any form of communication between nodes is intact, network flakiness on the channel used for heartbeat messages does not affect the cluster view.

A node health score can be implemented. For example, a node in the cluster evaluates the health score of each of its neighboring nodes by computing the average message loss, which is an estimate of how many incoming messages from that node are lost. This can be computed periodically as a weighted moving average of expected number of messages received and actual number of messages received. For example, let ‘t’ be the heartbeat messages transmit interval, ‘w’ be the length of the sliding window over which average is computed, ‘r’ be the number of heartbeat messages received, lw be the fraction of messages lost in this window, α be a smoothing factor and lₐ be the average message loss then la is computed as,

$$\begin{matrix}lw = messages lost / messages expected \\ = ( w * t - r ) / ( w * t )\end{matrix}$$

$$la = ( α * la ) + ( 1 - α ) * lw$$

The value of α can be set to 0.95 in one example. This can provide more weightage to average value over recent ones. The window length can be one-thousand milliseconds (1000 ms).

In some embodiments, a node whose average message loss exceeds two times the standard deviation is an outlier and deemed as unhealthy. An erratically behaving node can have a high average message loss and can also deviate significantly from the average node behavior. If an unhealthy node is a member of the cluster, it can be removed from the cluster. If it is not a member it is not considered for membership until its average message loss falls within tolerable limits.

A cluster view change operation can be implemented. Changes the adjacency list can trigger consensus via running an instance of a Paxos consensus algorithm to arrive at a new cluster view. A node that sees its node identifier as being the highest in its adjacency list acts as a Paxos proposer and assumes the role of the Principal. The Paxos Principal can then propose a new cluster view. If the proposal is accepted, nodes can begin redistribution of the data to maintain uniform data distribution across the new set of cluster nodes. In one example, a successful Paxos round may take three (3) network round trips to converge if there are no opposing proposals. This implementation can minimize the number of transitions the cluster would undergo as an effect of a single fault event. For example, a faulty network switch could make a subset of the cluster members unreachable. Once the network is restored these nodes can be added back to the cluster.

If each lost or arriving node triggers the creation of a new cluster view, the number of cluster transitions can equal the number of nodes lost or added. To minimize such transitions, nodes can make cluster change decisions at the start of fixed cluster change intervals (e.g. the time of the interval is configurable). Accordingly, the operation can process a batch of adjacent node events with a single cluster view change. In one example, a cluster change interval equal to twice a node's timeout setting can ensure that nodes failing due to a single network fault are detected in a single interval. It can also handle multiple fault events that occur within a single interval. A cluster management scheme can allow for multiple node additions or removals at a time. Accordingly, the cluster can be scaled out to handle spikes in load without downtime.

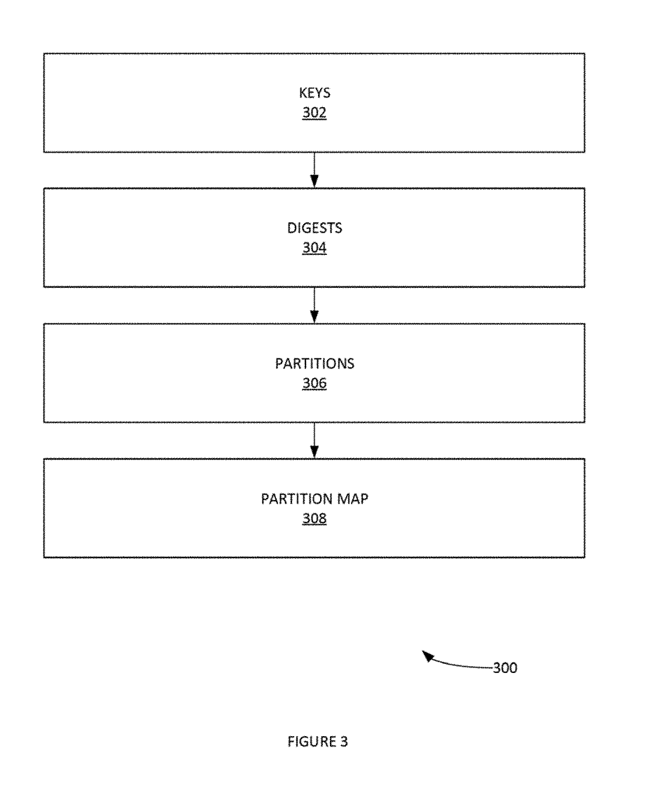

A data distribution method can be implemented. FIG. 3 illustrates an example 300 data distribution across nodes of a distributed database system (e.g. DDBS 100, etc.), according to some embodiments. A record's primary key(s) 302 can be hashed into a one-hundred and sixty (160) byte digest (e.g. using RipeMD160) 304. This can be robust against collision. The digest space can be partitioned into four-thousand and ninety-six (4096) non-overlapping ‘partitions’. This may be the smallest unit of ownership of data in in the database system. Records can be assigned partition(s) 306 based on the primary key digest 304. Even if the distribution of keys 302 in the key space is skewed, the distribution of keys in the digest space and therefore in the partition space 308 can be uniform. This data-partitioning scheme can contribute in avoiding the creation of hotspots during data access that helps achieve high levels of scale and fault tolerance.

The DBMS can collocate indexes and/or data to avoid any cross-node traffic when, running read operations or queries. Writes may involve communication between multiple nodes based on the replication factor. Colocation of index and data when combined with a robust data distribution hash function results in uniformity of data distribution across nodes. This ensures that, inter alia: application workload is uniformly distributed across the cluster; performance of Database operations is predictable; scaling the cluster up and down is easy, and/or live cluster reconfiguration and subsequent data rebalancing is simple, non-disruptive and efficient.

A partition assignment algorithm can generate a replication list for the partitions. The replication list can be a permutation of the cluster succession list. The first node in the partition's replication list can be the master for that partition; the second node can be the first replica and so on. The result of partition assignment can be called a partition map. It is also noted, that in some examples of a well-formed cluster, only one master for a partition may be extant at any given time. By default, the read/write traffic can be directed toward master nodes. Reads can also be spread across the replicas via a runtime configuration. The DBMS can support any number of replicas from one to as many nodes in cluster.

The partition assignment algorithm has the following objectives:

1. Be deterministic so that each node in the distributed system can independently compute the same partition map,

2. Achieve uniform distribution of partition masters and replicas across the nodes in the cluster, and;

3. Minimize movement of partitions on cluster view changes.

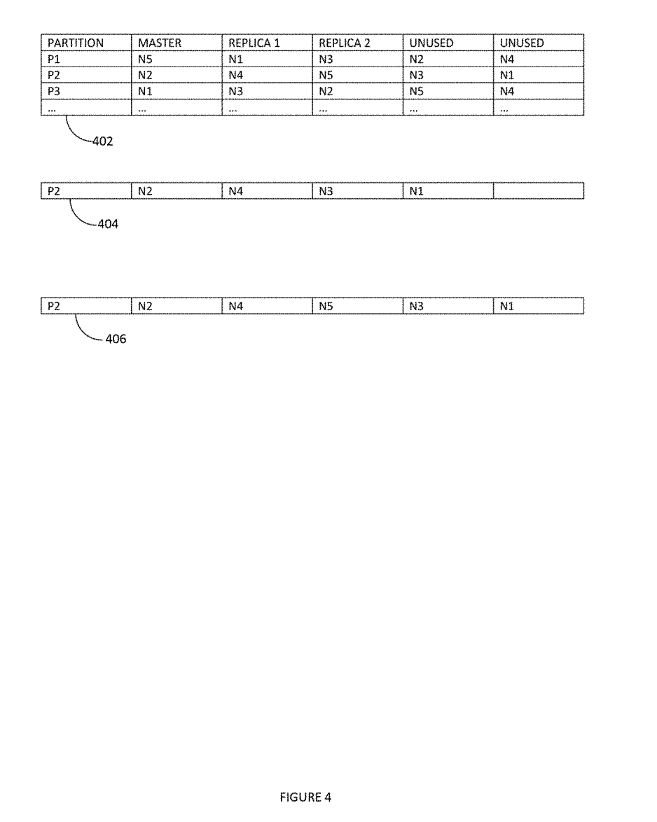

FIG. 4 illustrates an example partition assignment algorithm 400, according to some embodiments. More specifically, section 8(a) shows the partition assignment for a five-node cluster with replication factor of three. The first three columns (e.g. equal to the replication factor, etc.) in the partition map can be used and the last two columns can be unused.

Consider the case where a node goes down. It is easy to see from the partition replication list that this node can be removed from the replication list causing a left shift for subsequent nodes as shown in section 8(b). If this node did not host a copy of the partition, this partition may not use data migration. If this node hosted a copy of the data, a new node can take its place and would need a copy of the records in this partition to the new node. Once the original node returns and becomes part of the cluster again, it can regain its position in the partition replication list as shown in section 8(c). Adding a new node to the cluster may have the effect of inserting this node at some position in the various partition replication lists and result in the right shift of the subsequent nodes for each partition. Assignments to the left of the new node are unaffected. Algorithm 800 can minimize the movement of partitions (e.g. as migrations) during cluster reconfiguration. Thus, the assignment scheme achieves objective three supra.

When a node is removed, and rejoins the cluster, it may have missed out on the transactions applied while it was away and needs catching up. Alternatively, when a new node joins a running cluster with lots of existing data and happens to own a replica or master copy of a partition, the new node needs to obtain the latest copy of the records in that partition and also be able to handle new read and write operations. The mechanisms by which these issues are handled are described infra.

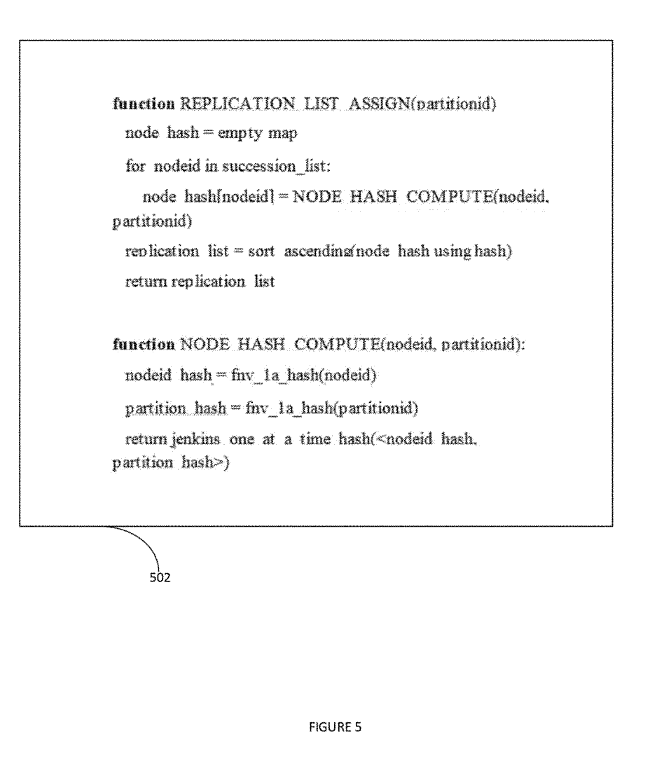

FIG. 5 illustrates an example table 500 that includes an example partition assignment algorithm, according to some embodiments. The algorithm is described as pseudo-code in table 500 of FIG. 5. Table 500 illustrates an algorithm that is deterministic in achieving objective 1 provided supra. The assignment can include a NODE_HAS_COMPUTE function that maps a node id and the partition id to a hash value. It is noted that a specific node's position in the partition replication list is its sort order based on the node hash. Running a Jenkins one-at-a-time hash on the FNV-1a can hash of the node and partition IDS can provide a good distribution and can achieve objective two supra as well.

Data Migrations method and systems are now discussed. The process of moving records from one node to another node is termed as migration. After a cluster view change, an objective of data migration is to have the latest version of each record available at the current master and replica nodes for each of the data partitions. Once a consensus(s) is arrived at on a new cluster view, the nodes in the cluster run the distributed partition assignment algorithm and assign the master and one or more replica nodes to each of the partitions.

For each partition, a master node can assign a unique partition version to the partition. The version number can be copied over to the replicas. After cluster view change, the partition versions for a partition with, data are exchanged between the nodes. Each node thus knows the version numbers for a copy of the partition.

Delta-Migrations method and systems are now discussed. The DBMS uses a few strategies to optimize migrations by reducing the effort and time taken, as follows. The DBMS can define a notion of ordering in partition versions so when a version is retrieved from disk it need not be migrated. The process of data migration may be more efficient if a total order could be established over partition versions. For example, if the value of a partition's version on node 1 is less than the value of the same partition 's version on node two (2), the partition version on node 1 could be discarded as obsolete. When version numbers diverge on cluster splits caused by network partitions, this can use the partial order to be extended to a total order (e.g. by order extension principle). Moreover, the amount of information used to create a partial order on version number can grow with time. The DBMS can maintain this partition lineage up to certain degree.

When two versions come together, nodes can negotiate the difference in actual records and send over the data corresponding to the differences between the two versions of partitions. In certain cases, migration can be avoided based on partition version order and, in other cases like rolling upgrades, the delta of change may be small and could be shipped over and reconciled instead of shipping the entire content of partitions.

Operations during migrations are now provided. If a read operation lands on a master node when migrations are in progress, the DBMS can guarantee the eventual winning copy of the record is returned. For partial writes to a record, the DBMS can guarantee that the partial write is to happen on the eventually winning copy. To ensure these semantics, operations enter a duplicate resolution phase during migrations. During duplicate resolution, the master reads the record across its partition versions, resolves to one. Copy of the record (the latest) which is the winning copy used for the read or write transaction.

Master partitions without data are now discussed. An empty node newly added to a running cluster can be master for a proportional fraction of the partitions and have no data for those partitions. A copy of the partition without any data can be marked to be in a DESYNC state. Read and write requests on a partition in DESYNC state can involve duplicate resolution since it has no records. An optimization that the DBMS can implement is to elect the partition version with the highest number of records as the acting master for this partition. Reads can be directed to the acting master if the client applications are compatible with older versions of records, duplicate resolution on reads can turned off. Thus, read requests for records present on the acting master will not duplicate resolution and have nominal latencies. This acting master assignment can last until migration is complete for this partition.

Migration ordering is now discussed. Duplicate resolution can add to the latency when migrations are ongoing in the cluster. Accordingly, migrations can be completed in a timely manner. However, in some examples, a migration may not be prioritized over normal read/write operations and cluster management operations. Given this constraint, the DBMS can apply a couple of heuristics to reduce the impact of data migrations on normal application read/write workloads.

Smallest partition first operations are now discussed. Migration can be coordinated in such a manner that nodes with the least number of records in their partition versions a migration first. The impact of this strategy may reduce the number of different copies of the partition faster than any other strategy.

Hottest-partition first operations are now discussed. At times, client accesses may be skewed to a small number of keys from the key space. Therefore, the latency on these accesses can be improved by migrating these hot partitions before other partitions thus reducing the time spent in duplicate resolution.

Time to load the primary index is now discussed. The primary index can be in memory and not persisted to a persistent device. On a node restart, if the data is stored on disk, the index is rebuilt by scanning records on the persistent device. The time taken to complete index loading can, then be a function of the number of records on that node and the device speed. To avoid rebuilding the primary index on a process restart, the primary index can be stored in a shared memory space disjoint from the service process's memory space. In the case the maintenance can perform a restart of the DBMS service, the index need not be reloaded. The service attaches to the current copy of index and is ready to handle transactions. This form of service start re-using an existing index is termed as ‘fast start’ and it can eliminate scanning the device for rebuilding the index.

Uniform distribution of transaction workload, data and associated metadata like indexes can make capacity planning and/or scaling up and down decisions precise and simple for the clusters. The DBMS can implement redistribution of data on changes to cluster membership. As opposed to alternate key range based partitioning scheme, which uses redistribution of data whenever a range becomes ‘larger than the capacity on its node.

A client-server paradigm is now discussed. The client layer can absorb the complexity of managing the cluster and there are various challenges to overcome here. A few of them are addressed below. The client can know the nodes of the cluster and their roles. Each node maintains a list of its neighbor nodes. This list can be used for the discovery of the cluster nodes. The client starts with one or more of seed nodes and discover the entire cluster. Once the nodes are discovered, it can know the role of each node. As described supra, each node can manage a master or replica for some partitions out of the total list of partitions. This mapping for partition to node (e.g. a partition map) can be exchanged and cached with the clients. The sharing of the partition map with the client can be used in making the client-server interactions more efficient. Therefore, there is single-hop access to data from the client. In steady state, the system can scale linearly as one adds clients and servers. Each client process can store the partition map in its memory. To keep the information up to date, the client process can periodically consult the server nodes to check if there are any updates by checking the version that it has with the latest version of the server. If there is any, update, it can request for the full partition map.

Frameworks (e.g., php-cgi, node.js cluster, etc.) can run multiple instances of the client process on each machine to use more parallelism. As the instances of the client can be on the same machine, they can be able to share this information between themselves. The DBMS can use a combination of shared memory and/or robust mutex code from the pthread library to solve the problem. Pthread mutexes can support the following properties that can be used across processes:

PTHREAD_MUTEX_ROBUST_NP

PTHREAD_PROCESS_SHARED

A lock can be created in a shared memory region with these properties set. The processes periodically compete to take the lock. One process may obtain the lock. The process that obtains the lock, can fetch the partition map from the server nodes and shares it with other processes via shared memory. If the process holding the lock dies, and when a different process tries to obtain the lock, it obtains the lock with the return code EOWNERDEAD. It can call pthread_mutex_consistent_np()to make the lock consistent for further use.

Cluster node handling is now discussed. For each of the cluster nodes, at the time of initialization, the client creates an in-memory structure on behalf of that node and stores its partition map. It can also maintain a connection pool for that node. This can be torn down when the node is declared down. Also in case of failure, the client can have a fallback plan to handle the failure by retrying the Database operation on the same node or on a different node in the cluster. If the underlying network is flaky and this repeatedly happens, this can end up degrading the performance of the overall system. This can lead to the use of a balanced approach of identifying cluster node health. The following strategies can be used by The DBMS to achieve the balance.

A Health Score can be implemented. The server node contacted may temporarily fail to accept the transaction request. Or it could be a transient network issue while the server node is up and healthy. To discount such scenarios, clients can track the number of failures encountered by the client on database operations at a specific cluster node. The client can drop a cluster node when the failure count (e.g. a “happiness factor”) crosses a particular threshold. Any successful operation to that node will reset the failure count to 0.

A Cluster Consultation can be implemented. For example, there can be situations where the cluster nodes can see each other but the client is unable to see some cluster nodes directly (say, X). The client, in these cases, can consult the nodes of the cluster visible to itself and sees if any of these nodes has X in their neighbor list. If any client-visible node in the cluster reports that X is in its neighbor list, the client does nothing. If no client-visible cluster nodes report X as being in its neighbor list, the client will wait for a threshold time, and then permanently remove the node.

A Cross Datacenter Replication (XDR) example now discussed. In some example multiple DBMS clusters can be stitched together in different geographically distributed data centers to build a globally replicated system. XDR can support different replication topologies, including active-active, active-passive, chain, star and multi-hop configurations.

For example, XDR can implement load sharing. A shared nothing model can be followed, even for cross datacenter replication. In a normal deployment state (e.g. when there are no failures), each node can log the operations that happen on that node for both master and/or replica partitions. However, each node can ship the data for master partitions on the node to remote clusters. The changes logged on behalf of replica partitions can be used when there are node failures. For each master partition on the failed node, the replica can be on some other node in the cluster. If a node fails, the other nodes detect this failure and takeover the portion of the pending work on behalf of the failed node. This scheme can scale horizontally as one can just add more nodes to handle more replication load.

XDR can implement data shipping. For example, when a write happens, the system first logs the change, reads the whole record and ships it. There can be a various optimizations to save the amount of data read locally and shipped across. For example, the data can be read in batches from the log file. It can be determined if the same record is updated multiple times in the same batch. The record can be read exactly once on behalf of the changes in that batch. Once the record is read, the XDR system can compare its generation with the generation recorded in the log file. If the generation on the log file is less than the generation of the record, it can skip shipping the record. There is an upper bound on the number of times the XDR system can skip the record, as the record may never be shipped if the record is updated continuously.

XDR can implement remoteuster management. For example, the XDR component on each node acts as client to the remote cluster. It can perform the roles just like a regular client (e.g. can keep track of remote cluster state changes, connects to the nodes of the remote cluster, maintains connection pools, etc.). This is a very robust distributed shipping system and there is no single point of failure. Nodes in the source cluster can ship data proportionate to their partition ownership and the nodes in the destination cluster receive data in proportion to their partition ownership. This shipping algorithm can allow source and destination clusters to have different cluster sizes. The XDR system can ensure that clusters continue to ship new changes as long as there is at least one surviving node in the source or destination clusters. It also adjusts to new node additions in source or destination clusters and is able to equally utilize the resources in both clusters.

XDR can implement pipelining. When doing cross data-center shipping, XDR can use an asynchronous pipelined scheme. As mentioned supra each node in source cluster can communicate with the nodes in the destination cluster. Each shipping node can maintain a pool of sixty-four (64) open connections to ship records. These connections can be used in a round robin way. The record can be shipped asynchronously. For example, multiple records can be shipped on the open connection and the source waits for the responses afterwards. So, at any given point in time, there can be multiple records on the connection waiting to be written at the destination. This pipelined model can be used to deliver high throughput on high latency connections over a WAN. When the remote node writes the shipped record, it can send an acknowledgement back to the shipping node with the return code. The XDR system can set an upper limit on the number of records that can be in flight for the sake of throttling the network utilization.

Various system optimizations for scaling up can be implemented. For a system to operate at high throughput with low latency, it can scale out across nodes and also scale up on one node. In some examples, the techniques covered here can apply to any data storage system in general. Ability to scale up on nodes can means, inter alia: scale up to higher throughput levels on fewer nodes: better failure characteristic since probability of a node failure typically increases as number of nodes in cluster increase; easier operational footprint. Managing a 10-node cluster versus a 200-node cluster is a huge win for operators; lower total cost of ownership. This is especially true once you factor in the SSD based scaling that is described in section; etc.

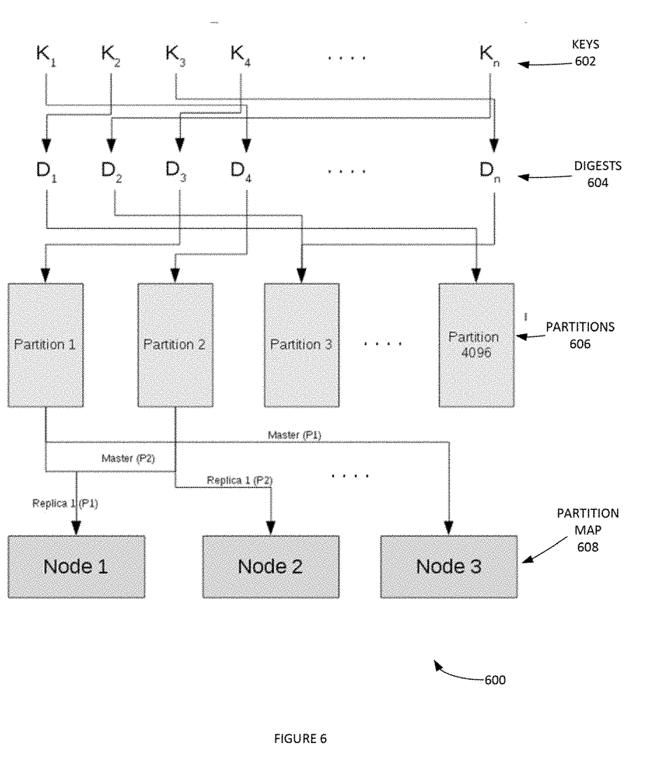

FIG. 6 illustrates another example process 600 of data distribution across nodes of a DDBS, according to some embodiments. Process 600 can hash a set of primary keys 602 of a record into a set of digests 604. Digest 604 can be a part of a digest space of the DDBS. The digest space can be partitioned into a set of non-overlapping partitions 606. Process 600 can implement a partition assignment algorithm. The partition assignment algorithm can generate a replication list for the set of non-overlapping partitions. The replication list can include a permutation of a cluster succession list. A first node in the replication list comprises a master node for that partition. A second node in the replication list can include a first replica. The partition assignment algorithm can use the replication list to generate a partition map 608.

Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A method of a data distribution across nodes of a Distributed Database Base System (DDBS) comprising:
hashing a primary key of a record into a digest, wherein the digest is part of a digest space of the DDBS;
partitioning the digest space of the DDBS into a set of non-overlapping partitions;
implementing a partition assignment algorithm, wherein the partition assignment algorithm:
generating a replication list for the set of non-overlapping partitions;
wherein the replication list comprises a permutation of a cluster succession list,
wherein a first node in the replication list comprises a master node for that partition, and
wherein a second node in the replication list comprises a first replica, and
using the replication list to generate a partition map.

2. The method of claim 1, wherein the RIPEMD (RACE Integrity Primitives Evaluation Message Digest).

3. The method of claim 1, wherein the digest comprises a one-hundred and sixty (160) byte digest.

4. The method of claim 3, wherein the non-overlapping partition comprises a set of four-thousand and ninety-six (4096) non-overlapping partitions.

5. The method of claim 4, wherein each non-overlapping partition is a smallest unit of ownership of data in in the DDBS.

6. The method of claim 6, wherein a distribution of primary keys in the digest space is uniform.

7. The method of claim 6, wherein the DDBS collocates set of indexes and a set of related data.

8. The method of claim 7,
wherein only one master node is extant in the DDBS for a partition,
wherein all write operation traffic is directed toward the master node.

9. The method of claim 7, wherein read operation traffic is spread across a set of replicas indicated in the replication list via a runtime configuration, and wherein the DDBS supports specified number of replicas from one to as many nodes in a cluster.

10. A computerized system of data distribution across a set of nodes of a Distributed Database Base System (DDBS) comprising:
a processor configured to execute instructions;
a memory including instructions when executed on the processor, causes the processor to perform operations that:
hashes a primary key of a record into a digest, wherein the digest is part of a digest space of the DDBS;
partitions the digest space of the DDBS into a set of non-overlapping partitions;
implements a partition assignment algorithm, wherein the partition assignment algorithm:
generates a replication list for the set of non-overlapping partitions;
wherein the replication list comprises a permutation of a cluster succession list,
wherein a first node in the replication list comprises a master node for that partition, and
wherein a second node in the replication list comprises a first replica, and
uses the replication list to generate a partition map.

11. The computerized system of claim 10, wherein the RIPEMD (RACE Integrity Primitives Evaluation Message Digest).

12. The computerized system of claim 10, wherein the digest comprises a one-hundred and sixty (160) byte digest.

13. The computerized system of claim 12, wherein the non-overlapping partitions comprises a set of four-thousand and ninety-six (4096) non-overlapping partitions.

14. The computerized system of claim 13, wherein each non-overlapping partition is a smallest unit of ownership of data in in the DDBS.

15. The computerized system of claim 14, wherein a distribution of primary keys in the digest space is uniform.

16. The computerized system of claim 15, wherein the DDBS collocates a set of indexes and a set of related data.

17. The computerized system of claim 16, wherein only one master node is extant in the DDBS for a partition,

18. The computerized system of claim 16, wherein all write operation traffic is directed toward the master node.

19. The computerized system of claim 16, wherein read operation traffic is spread across a set of replicas indicated in the replication list via a runtime configuration.

20. The computerized system of claim 16, wherein the DDBS supports a specified number of replicas from one to as many nodes in a cluster.
